(19) United States
(12) Patent Application Publication
(10) Pub. No.: US 2014/0238754 A1
(43) Pub. Date: Aug. 28, 2014

(54) ELECTRIC WEIGH PACKER AND A WEIGHING METHOD ACCORDING TO THE PARTICLE NUMBERS

(71) Applicant: SHANGHAI YAMATO SCALE CO., LTD., SHANGHAI (CN)

(72) Inventors: Youjun Liao, Shanghai (CN); Aoxing Ge, Shanghai (CN); Yingxin Cui, Shanghai (CN); Bin Zong, Shanghai (CN)

(73) Assignee: SHANGHAI YAMATO SCALE CO., LTD, SHANGHAI (CN)

(21) Appl. No.: 14/114,749

(22) PCT Filed: Nov. 12, 2012
(86) PCT No.: PCT/CN2012/001519

§ 371 Date: Oct. 29, 2013

(30) Foreign Application Priority Data
Jun. 20, 2012 (CN) 201210204443.3

(51) Int. Cl. G01G 19/42

(52) U.S. Cl. CPC G01G 19/42
USPC 177/1; 177/25.18

(57) ABSTRACT

The present invention is related to a quantifying packaging balance for weighing according to the number of the goods, characterized in that the balance includes a storage funnel, unit particle weight obtaining unit and a quantifying packaging unit, wherein the unit particle weight obtaining unit comprises a sampling device (2), a feeding device (3), multiple line vibrator (4), a storage channel (7), a camera (5), a camera control device, a light source (6) and an input device, wherein the quantifying packaging unit is a one-head quantifying packaging balance or a multiple-head quantifying packaging balance, and comprises a dividing channel (9), a feeding device (10), quantifying funnels (8, 11) and a weight control device, wherein the unit particle weight obtaining unit and all the components of the quantifying packaging unit are coordinated by PLC. The balance according to the current invention can obtain the unit particle weight in time, amend the weight being packaged and thus improve the packaging accuracy.

### FIELD OF THE INVENTION

The present application is related to a scale and a weighing method, especially an electronic weigh packer and a weighing method according to the particle number.

### BACKGROUND

A particle counting device is the most direct solution for packaging according to the particle numbers. However, since the particle counting device is slow and pricy, the goods are packaged using an electronic weigh packer according to the unit weight of the particles which is then converted to target weight. In comparison with direct counting method, the weighing method using the weight of the particles is fast and cost efficient. Nevertheless, when the weight of each particle is different, even though the weight of each package using the electronic weigh packer is the same (that is to say, the standard is the same), the number of the particles still varies significantly.

### SUMMARY

The object of the current invention is to provide an electronic weigh packer and a weighing method according to the particle number, which can overcome the above mentioned technical problems. The scale according to the current invention can obtain the unit particle weight in time, amend the weight being packaged and thus improve the packaging accuracy.

The current invention achieves the above mentioned goal as follows:

An electronic weigh packer for weighing according to the number of the goods, characterized in that the scale includes a storage funnel, unit particle weight obtaining unit and a quantifying packaging unit, wherein
the unit particle weight obtaining unit comprises a sampling device, a feeding device, a multiple line vibrator, a storage channel, a camera, a camera controller, a light source and an input device, wherein the quantifying packaging unit is a one-head electronic weigh packer or a multiple-head electronic weigh packer, and comprises a dividing channel, a feeding device, weighing hoppers and a weighing controller, wherein the unit particle weight obtaining unit and all the components of the quantifying packaging unit are coordinated by PLC;
the unit particle weight obtaining unit also contains a counting & weighing hopper, wherein the function of the counting & weighing hopper is to weigh the goods lined and numbered by the multiple line vibrator, and the counting & weighing hopper can be separately set up or can be used together with one of the weighing hoppers;
the sampling device is situated inside the storage funnel, whose function is to sample the goods to be wrapped and to feed the sampled goods into the feeding device;
the function of the feeding device is to evenly feed the goods into to the multiple line vibrator;
the function of the multiple line vibrator is to accelerate the goods inside its channel and to line up all the particles inside the channel in order to prevent overlapping of the particles, and the particles descend into the storage channel with a door;
the camera coordinates with the light source to scan the descending particles with high velocity and transfers the images to the camera controller;
the camera controller analyzes the images and count the particle number;
the function of the storage channel is: when the number of the particles reaches a certain number, the bottom door of the storage channel will open and the particles with the certain number will be weighed in the counting & weighing hopper, and when the counting & weighing hopper is used together with one of the weighing hoppers, a bottom door should be designed at the bottom of the storage channel;
the function of the PLC is to calculate the unit particle weight according to the particle number and the total weight of the collective particles, and to calculate the package weight according to the stipulated number of particles for each package and to amend the weight value assigned by the scale;
the function of the weighing controller is to assign the weight value according to the weight value set by the PLC;
the dividing channel is situated below the storage funnel, and the goods are fed into the weighing hopper from all of its outlet openings through all the feeding devices.

A method for using the electronic weigh packer for weighing according to the number of the goods, characterized in that the method comprises the following steps:
first, setting packing specification of electronic weigh packer, which is the target particle number and particle counting number of unit weight obtaining unit through the input device;
after setting completed, start unit weight obtaining unit and counting begins;
stopping counting particle number when the number counted has reached the assigned number; obtaining the goods weight using the counting & weighing hopper; calculating the unit particle weight using PLC and calculating the package weight according to the stipulated package specification and input into weighing controller of electronic weigh packer;
electronic weigh packer starts weighing;
amending the package weight using the unit particle weight given by the unit particle weight obtaining unit continuously.

A method for using the electronic weigh packer for weighing characterized in that the package weight is adjusted every tens of seconds when particle number obtained can fully represent the goods being wrapped.

A method for using the electronic weigh packer for weighing, characterized in that when the packaging specification of the scale is being set and the unit particle number is being set via the unit particle weight, the different operating methods are as follows:
when the particle number set by the unit particle weight obtaining unit each time equals the packaging specification, the particles of the set number are weighed by the weighing hopper, after the unit particle weight is obtained, the goods are discharged into the packaging container;
when the particle number set by the unit particle weight obtaining unit each time is smaller than the packaging specification, the particles of the set number are weighed by the weighing hopper, after the unit particle weight is obtained, the particles lacked are added by the feeding device of the scale, and the goods are then discharged into the packaging container;
when the particle number set by the unit particle weight obtaining unit each time is bigger than the packaging specification, the particles are divided by the target particle number to be packaged and numbered separately, and numbers resulted are added and the unit particle number is then calculated, when the number of the particles reaches the target number, the particles are fed into the weighing hopper and weighed and memorized, and the goods are discharged by the weighing hopper into the packaging container; when the particle number counted the last time is less than the target particle number, the lacked particles will be added by the feeding device.

A method for using the electronic weigh packer for weighing, characterized in that the particle number calculating method is: the particles of the small sample is calculated each time, and the unit particle weight is calculated by moving average or weighted moving average.

A method for using the electronic weigh packer for weighing, characterized in that the unit particle weight calculating method is: the big samples are used for calculating the particles, and the unit particle weight is calculated by moving average or weighted moving average.

The advantage of the device and the method of the current invention is: it can timely obtain the unit weight of the goods, amend the packaging weight and improve the accuracy of the packaging according to the particle numbers.

### DESCRIPTION OF THE DRAWINGS

FIG. 1 shows the structure of a relatively optimum example of the present invention.

### EMBODIMENTS CARRYING OUT THE INVENTION

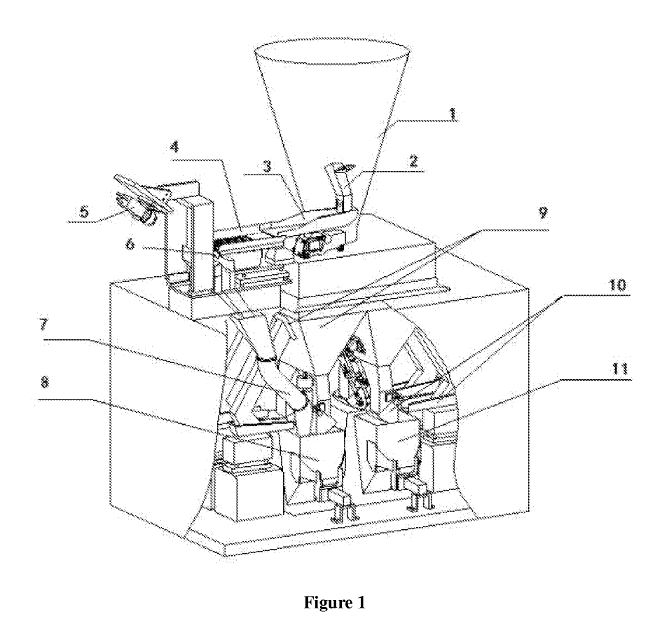

According to FIG. 1, the current invention discloses an electronic weigh packer for weighing according to the number of the goods, comprising a storage funnel 1, unit particle weight obtaining unit and a quantifying packaging unit, wherein the unit particle weight obtaining unit comprises a sampling device 2, a feeding device 3, multiple line vibrator 4, a storage channel 7, a camera 5, a camera controller, a light source 6 and an input device, wherein the quantifying packaging unit is a one-head electronic weigh packer or a multiple-head electronic weigh packer, and comprises a dividing channel 9, a feeding device 10, weighing hoppers 8, 11 and a weighing controller, wherein the unit particle weight obtaining unit and all the components of the quantifying packaging unit are coordinated by PLC.

The unit particle weight obtaining unit also contains a counting & weighing hopper, wherein the function of the counting & weighing hopper is to weigh the goods lined and numbered by the multiple line vibrator, and the counting & weighing hopper shares with weighing hopper 8.

The sampling device 2 is situated inside the storage funnel 1, whose function is to sample the goods to be wrapped and to feed the sampled goods into the feeding device 3.

The function of the feeding device 3 is to evenly feed the goods into to the multiple line vibrator 4.

The function of the multiple line vibrator 4 is to accelerate the goods inside its channel and to line up all the particles inside the channel in order to prevent overlapping of the particles, and the particles descend into the storage channel 7 with a door.

The camera 5 coordinates with the light source 6 to scan the descending particles with high velocity and transfers the images to the camera controller.

The camera controller analyzes the images and counts the particle number.

The function of the storage channel 7 is: when the number of the particles reaches a certain number, the bottom door of the storage channel will open and the particles with the certain number will be weighed in the counting & weighing hopper.

The function of the PLC is to calculate the unit particle weight according to the particle number and the total weight of the collective particles, and to calculate the package weight according to the stipulated number of particles for each package and to amend the weight value assigned by the electronic weigh packer.

The function of the weighing controller is to assign the weight value according to the weight value set by the PLC.

The dividing channel 9 is situated below the storage funnel 1, and the goods are fed into the weighing hopper 8, 11 from all of its outlet openings through all the feeding devices 10.

The current invention utilises high quality cameras in order to obtain high definition visible wave profile. The camera applied in the current invention can be German BASLER cameras or any industrial cameras with equal functions.

The PLC of the current invention can be Mitsubishi Q series or FX series.

The weighing controller of the current invention can be Japanese Yamato EDI-801 or FEC-710.

The camera controller can be the IN-SIGHT MICRO series from COGNEX, America.

As a preferred embodiment, the sampling device 2 is located above the sampling spot of the dividing channel 9. As a result, the unit particle weight corresponds completely with the goods actually packed. Since the weight and the size of each particle are different, in order to prevent funneling effect, the sampling takes place on one line instead of one spot, so that the samples are representative.

A method for using the electronic weigh packer for weighing according to the number of the goods as described above, characterized in that the method comprises the following steps:
first, setting packing specification of electronic weigh packer, which is the target particle number and particle counting number of unit weight obtaining unit through the input device;
after setting completed, start unit weight obtaining unit and counting begins;
stopping counting particle number when the number counted has reached the assigned number; obtaining the goods weight using the counting & weighing hopper; calculating the unit particle weight using PLC and calculating the package weight according to the stipulated package specification and input into weighing controller of electronic weigh packer;
electronic weigh packer starts weighing;
amending the package weight using the unit particle weight given by the unit particle weight obtaining unit continuously.

Only when the unit particle weight is obtained in a fast manner, the weight change of unit material to be packed can be detected in a timely manner. The method of the current invention counts the particle number using multiple channels, the particle number counted within a certain period of time is higher, and therefore the unit particle weight is more accurate. According to the present invention, the package weight is adjusted every tens of seconds while the particle number counted every time can fully represent the goods being wrapped.

According to the method of the current invention, when the packaging specification of the scale is being set and the unit particle number is being set via the unit particle weight, the different operating methods are as follows:
when the particle number set by the unit particle weight obtaining unit each time equals the packaging specification, the particles of the set number are weighed by the weighing hopper, after the unit particle weight is obtained, the goods are discharged into the packaging container;
when the particle number set by the unit particle weight obtaining unit each time is smaller than the packaging specification, the particles of the set number are weighed by the weighing hopper, after the unit particle weight is obtained, the particles lacked are added by the feeding device of the scale, and the goods are then discharged into the packaging container;
when the particle number set by the unit particle weight obtaining unit each time is bigger than the packaging specification, the particles are divided by the target particle number to be packaged and numbered separately, and numbers resulted are added and the unit particle number is then calculated, when the number of the particles reaches the target number, the particles are fed into the weighing hopper and weighed and memorized, and the goods are discharged by the weighing hopper into the packaging container; when the particle number counted the last time is less than the target particle number, the lacked particles will be added by the feeding device.

A method for using the electronic weigh packer for weighing, characterized in that the particle number calculating method is: the particles of the small sample is calculated each time, and the unit particle weight is calculated by moving average or weighted moving average.

According to the method of the current invention, the weight calculating method of the unit particle weight can vary according to the different characteristics of the different goods. The method can be as follows:

1) Using the small sample number to calculate the unit particle by moving average or weighted moving average.

Using 3 times as an example:

The unit particle weight of the first time is A;

The unit particle weight of the second time is B;

The unit particle weight of the third time is C. The first unit particle weight a is obtained by averaging A, B, C (or weighted average).

The unit particle weight of the fourth time is D. The second unit particle weight b is obtained by averaging B, C, D (or weighted average).

The unit particle weight of the fifth time is E. The third unit particle weight c is obtained by averaging C, D, E (or weighted average).

And so on so forth.

2) The particle number of the big sample each time is used to calculate the particle weight.

The unit particle weight of the first time is A, the first unit particle weight can be directly obtained a=A;

The unit particle weight of the first time is B, the second unit particle weight can be directly obtained b=B;

And so on so forth.

3) Using the particle number of each big sample to calculate unit particle weight by moving average or weighted moving average. The calculation method is the same as 1)

The above is just a preferred embodiment of the present invention. It by no means restricts the protection scope thereof. All amendments to the embodiment according to the present invention all belong to the scope of protection of the present invention.

What is claimed is:

1. A electronic weigh packer for weighing according to the number of the goods, characterized in that the scale includes a storage funnel (1), unit particle weight obtaining unit and a quantifying packaging unit, wherein
the unit particle weight obtaining unit comprises a sampling device (2), a feeding device (3), a multiple line vibrator (4), a storage channel (7), a camera (5), a camera controller, a light source (6) and an input device, wherein the quantifying packaging unit is a one-head electronic weigh packer or a multiple-head electronic weigh packer, and comprises a dividing channel (9), a feeding device (10), weighing hoppers(8, 11) and a weighing controller, wherein the unit particle weight obtaining unit and all the components of the quantifying packaging unit are coordinated by PLC;
the unit particle weight obtaining unit also contains a counting & weighing hopper, wherein the function of the counting & weighing hopper is to weigh the goods lined and numbered by the multiple line vibrator, and the counting & weighing hopper can be separately set up or can be used together with one of the weighing hoppers (8, 11);
the sampling device (2) is situated inside the storage funnel (1), whose function is to sample the goods to be wrapped and to feed the sampled goods into the feeding device (3);
the function of the feeding device (3) is to evenly feed the goods into to the multiple line vibrator (4);
the function of the multiple line vibrator (4) is to accelerate the goods inside its channel and to line up all the particles inside the channel in order to prevent overlapping of the particles, and the particles descend into the storage channel (7) with a door;
the camera (5) coordinates with the light source (6) to scan the descending particles with high velocity and transfers the images to the camera control device;
the camera controller analyzes the images and count the particle number;
the function of the storage channel (7) is: when the number of the particles reaches a certain number, the bottom door of the storage channel will open and the particles with the certain number will be weighed in the particle number counting funnel, and when the counting & weighing hopper is used together with one of the weighing hoppers (8, 11), a bottom door should be designed at the bottom of the storage channel (7);
the function of the PLC is to calculate the unit particle weight according to the particle number and the total weight of the collective particles, and to calculate the package weight according to the stipulated number of particles for each package and to amend the weight value assigned by the scale;
the function of the weighing controller is to assign the weight value according to the weight value determined by the PLC;
the dividing channel (9) is situated below the storage funnel (1), and the goods are fed into the weighing hoppers (8, 11) from all of its outlet openings through all the feeding devices (10).

2. An electronic weigh packer for weighing according to the number of the goods according to claim 1, characterized in that the sampling device (2) is located above the sampling spot of the dividing channel (9).

3. A method for using the electronic weigh packer for weighing according to the number of the goods according to claim 1 or 2, characterized in that the method comprises the following steps:
first, setting packing specification of electronic weigh packer, which is the target particle number and particle counting number of unit weight obtaining unit through the input device;
after setting completed, start unit weight obtaining unit and counting begins;
stopping counting particle number when the number counted has reached the assigned number; obtaining the goods weight using the counting & weighing hopper; calculating the unit particle weight using PLC and calculating the package weight according to the stipulated package specification and input into weighing controller of electronic weigh packer;
electronic weigh packer starts weighing;
amending the package weight using the unit particle weight given by the unit weight obtaining unit continuously.

4. A method for using the electronic weigh packer for weighing according to claim 3, characterized in that the package weight is adjusted every tens of seconds when particle number obtained can fully represent the goods being wrapped.

5. A method for using the electronic weigh packer for weighing according to claim 3, characterized in that when the packaging standard of the scale is being determined and the unit particle number is being determined via the unit particle weight, the different operating methods are as follows:
when the particle number determined by the unit particle weight obtaining unit each time equals the packaging specification, the particles of the determined number are weighed by the weighing hopper, after the unit particle weight is obtained, the goods are discharged into the packaging container;
when the particle number determined by the unit particle weight obtaining unit each time is smaller than the packaging specification, the particles of the determined number are weighed by the weighing hopper, after the unit particle weight is obtained, the particles lacked are added by the feeding device of the scale, and the goods are then discharged into the packaging container;
when the particle number determined by the unit particle weight obtaining unit each time is bigger than the packaging specification, the particles are divided by the target particle number to be packaged and numbered separately, and numbers resulted are added and the unit particle number is then calculated, when the number of the particles reaches the target number, the particles are fed into the weighing hopper and weighed and memorized, and the goods are discharged by the weighing hopper into the packaging container; when the particle number counted the last time is less than the target particle number, the lacked particles will be added by the feeding device.

6. A method for using the electronic weigh packer for weighing according to claim 3, characterized in that the particle number calculating method is: the particles of the small sample is calculated each time, and the unit particle weight is calculated by moving average or weighted moving average.

7. A method for using the electronic weigh packer for weighing according to claim 3, characterized in that the unit particle weight calculating method is: the big samples are used for calculating the particles, and the unit particle weight is calculated by moving average or weighted moving average.
